(19) United States
(12) Patent Application Publication
(10) Pub. No.: US 2019/0009400 A1
(43) Pub. Date: Jan. 10, 2019

(54) Packing Tape Dispenser Insert Apparatus, Systems and Methods of Using the Same

(71) Applicant: Creator's Stained Glass, Inc., Fox Lake, IL (US)

(72) Inventors: Ray Nicholas, Ingleside, IL (US); Ryan Nicholas, Ingleside, IL (US); Jordan Anderson, Gurnee, IL (US)

(21) Appl. No.: 16/020,644

(22) Filed: Jun. 27, 2018

Related U.S. Application Data
(60) Provisional application No. 62/529,992, filed on Jul. 7, 2017.

(51) Int. Cl. B25G 1/08; B65H 35/00; B26B 5/00; B26B 11/00; F16B 21/09

(52) U.S. Cl. CPC B25G 1/08; B65H 35/0033; F16B 2001/0035; B26B 11/00; F16B 21/09; B26B 5/006

(57) ABSTRACT

Packing tape dispenser insert apparatuses comprise a housing having a first end, a second end, a first side and a second side, a storage area within the housing, and a tab for engaging at least one slot within a handle of a packing tape dispenser. Systems and methods are further provided.

The present invention claims priority to U.S. Provisional Patent Application No. 62/525,992, titled “Packing Tape Dispenser Insert Apparatus, Systems and Methods of Using the Same,” filed Jul. 7, 2017, which is incorporated herein by reference in its entirety.

### TECHNICAL FIELD

The present invention relates to a packing tape dispenser insert apparatus. Specifically, the packing tape gun insert apparatus comprises a housing having a first end, a second end, a first side and a second side, a storage area within the housing, and a tab for engaging at least one slot within a handle of a packing tape dispenser. Systems and methods are further provided.

### BACKGROUND

Packing tape dispensers are well known and have been utilized for years to dispense packing tape to seal boxes, cartons, parcels, and other like containers for storage and/or shipping. The packing tape dispensers typically comprise a head having a roller on which a roll of tape is rotatably held, and a blade positioned adjacent the roller for cutting dispensed tape from the roll of tape. The packing tape dispenser further has a convenient handle for aiding a user in holding the packing tape dispenser in the proper configuration for dispensing tape and for cutting the tape with the blade.

Specifically, a user will engage a free end of the packing tape disposed on the roller of the packing tape dispenser and engage the adhesive side of the packing tape to a surface, typically to seal flaps of a box, carton, parcel or other like container. By grasping the handle of the tape dispenser and pulling rearwardly, the tape is dispensed from the tape dispenser thereby forming a strip of tape adhered to the surface. Further, by pulling upwardly (or otherwise away from the surface of the box, carton, parcel or other container), the blade engages the strip of tape, thereby severing the tape at a desired location. The strip of tape is then adhered to the surface, severed, and the tape dispenser may easily be used elsewhere.

Oftentimes, users of tape dispensers, especially for those in factories, warehouses, shipping facilities, or other like locations, typically require other tools or mechanisms to aid them in their work. For example, those that work in shipping facilities oftentimes need to open boxes, cartons, parcels or other like containers with other specialized tools. Specifically, a user may require a box cutter having one or more blades therein that may be utilized to slice open boxes.

A box cutter comprises a housing having a slotted end in which one or more double-ended blades reside. A spring-loaded tab or flange on a side thereof is slidable and engages the double-ended blade residing therein, thereby pushing a bladed end of the double-ended blade out through the slotted end, thereby exposing the bladed end to be used in cutting.

Of course, other like devices or items may be needed for use by an individual at the same time he or she uses a tape dispenser. For example, a user may wish to have writable tabs or stickers for placement on parcels for shipment, writing utensils, nuts, bolts, screws, or other like connection means, or any other device or item useful to one of ordinary skill in the art.

Typically, there is no convenient place to hold these devices or items, such as box cutters, or storage containers having storage spaces therein for other devices and/or items. Oftentimes, devices such as box cutters are frequently set down and misplaced. A need, therefore, exists for an apparatus useful for storing and/or utilizing devices or items that is conveniently located, especially when used in conjunction with a tape dispenser. Specifically, a need exists for a box cutter apparatus that may be useful when used in conjunction with a tape dispenser.

Tape dispensers, typically those that may be made and sold by Uline®, have handles that are hollow, and form convenient and spacious cavities. A need exists for an apparatus that may be utilized for storing and/or utilizing devices or items that may be held or otherwise stored within the hollow handle of a tape dispenser apparatus. More specifically, a need exists for a box cutter apparatus that may be held or otherwise stored within the hollow handle of a tape dispenser apparatus.

Moreover, quick and convenient access to an apparatus utilized for storing and/or utilizing devices or items therein, such as a box cutter apparatus, is necessary for utilization, especially for a worker in a factory, warehouse, shipping facility or the like, where oftentimes it is necessary to quickly obtain the apparatus for use thereof. A need, therefore, exists for an apparatus that may be held and/or stored within the hollow handle of a tape dispenser apparatus, and further may be quickly and easily accessed by a user thereof for utilization as needed. Specifically, a need exists for a box cutter apparatus that may be held and/or stored within the hollow handle of a tape dispenser apparatus that is easily and quickly accessible to be utilized by a user thereof.

### SUMMARY OF THE INVENTION

The present invention relates to a packing tape dispenser insert apparatus. Specifically, the packing tape gun insert apparatus comprises a housing having a first end, a second end, a first side and a second side, a storage area within the housing, and a tab for engaging at least one slot within a handle of a packing tape dispenser. Systems and methods are further provided.

To this end, in an embodiment of the present invention, a packing tape dispenser insert apparatus is provided. The packing tape insert apparatus comprises: a housing having a first end, a second end, a first side and a second side, wherein the housing is shaped and sized to be placed within a hollow handle of a packing tape dispenser; a holding element on the housing for engaging the hollow handle of the packing tape dispenser, the holding element configured to hold the housing within the hollow handle of the packing tape dispenser; and a release element wherein the release element is configured to release the housing from the hollow handle of the packing tape dispenser.

In an embodiment, the housing comprises at least one item.

In an embodiment, the item is a razor blade.

In an embodiment, the housing comprises a plurality of razor blades.

In an embodiment, the holding element is a tab on the housing, wherein the tab is configured to engage a mating element on an inside surface of the hollow handle of the packing tape dispenser.

In an embodiment, the holding element is magnetic.

In an embodiment, the release element comprises a spring, wherein depressing the release element causes the holding element to release the housing from the hollow handle of the packing tape dispenser.

In an alternate embodiment of the present invention, a packing tape dispenser insert system is provided. The system comprises: a packing tape dispenser comprising a dispensing head having a roll of tape therein, a blade for dispensing and cutting a strip of tape therefrom, and a hollow handle having a grip and comprising an interior cavity therein; and a packing tape dispenser insert apparatus comprising a housing having a first end, a second end, a first side and a second side, wherein the housing is shaped and sized to be placed within the hollow handle of the packing tape dispenser, a holding element on the housing for engaging the hollow handle of the packing tape dispenser, the holding element configured to hold the housing within the hollow handle of the packing tape dispenser, and a release element wherein the release element is configured to release the housing from the hollow handle of the packing tape dispenser.

In an embodiment, the housing comprises at least one item.

In an embodiment, the item is a razor blade.

In an embodiment, the housing comprises a plurality of razor blades.

In an embodiment, the holding element is a tab on the housing, wherein the tab is configured to engage a mating element on an inside surface of the hollow handle of the packing tape dispenser.

In an embodiment, the holding element is magnetic.

In an embodiment, the release element comprises a spring, wherein depressing the release element causes the holding element to release the housing from the hollow handle of the packing tape dispenser.

In an alternate embodiment of the present invention, a method of using a packing tape insert system is provided. The method comprises the steps of: providing a packing tape dispenser comprising a dispensing head having a roll of tape therein, a blade for dispensing and cutting a strip of tape therefrom, and a hollow handle having a grip and comprising an interior cavity therein; and providing a packing tape dispenser insert apparatus comprising a housing having a first end, a second end, a first side and a second side, wherein the housing is shaped and sized to be placed within the hollow handle of the packing tape dispenser, a holding element on the housing for engaging the hollow handle of the packing tape dispenser, the holding element configured to hold the housing within the hollow handle of the packing tape dispenser, and a release element wherein the release element is configured to release the housing from the hollow handle of the packing tape dispenser; inserting the housing into the hollow handle of the packing tape dispenser; and engaging the holding element to the hollow handle of the packing tape dispenser.

In an embodiment, the method further comprises the step of: engaging the release element, wherein engaging the release element disengages the holding element from the hollow handle of the packing tape dispenser.

In an embodiment, the housing comprises at least one item.

In an embodiment, the item is a razor blade.

In an embodiment, the holding element is magnetic.

In an embodiment, the release element comprises a spring, wherein the step of engaging the release element comprises the step of: depressing the release element, which causes the holding element to release the housing from the hollow handle of the packing tape dispenser.

It is, therefore, an advantage and objective of the present invention to provide an apparatus useful for storing and/or utilizing devices or items that is conveniently located, especially when used in conjunction with a tape dispenser.

Specifically, it is an advantage and objective of the present invention to provide a box cutter apparatus that may be useful when used in conjunction with a tape dispenser.

Moreover, it is an advantage and objective of the present invention to provide an apparatus that may be utilized for storing and/or utilizing devices or items that may be held or otherwise stored within the hollow handle of a tape dispenser apparatus.

More specifically, it is an advantage and objective of the present invention to provide a box cutter apparatus that may be held or otherwise stored within the hollow handle of a tape dispenser apparatus.

Further, it is an advantage and objective of the present invention to provide an apparatus that may be held and/or stored within the hollow handle of a tape dispenser apparatus, and further may be quickly and easily accessed by a user thereof for utilization as needed.

Still further, it is an advantage and objective of the present invention to provide a box cutter apparatus that may be held and/or stored within the hollow handle of a tape dispenser apparatus that is easily and quickly accessible to be utilized by a user thereof.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a packing tape dispenser and a packing tape insert apparatus in an embodiment of the present invention.

FIG. 2 illustrates a perspective view of a packing tape dispenser having a packing tape insert apparatus inserted therein in an embodiment of the present invention.

FIG. 3 illustrates a front view of a box cutter packing tape dispenser insert apparatus in an embodiment of the present invention.

FIG. 4 illustrates a rear view of a box cutter packing tape dispenser insert apparatus in an embodiment of the present invention.

### DETAILED DESCRIPTION OF THE PRESENTLY PREFERRED EMBODIMENTS

The present invention relates to a packing tape dispenser insert apparatus. Specifically, the packing tape gun insert apparatus comprises a housing having a first end, a second end, a first side and a second side, a storage area within the housing, and a tab for engaging at least one slot within a handle of a packing tape dispenser. Systems and methods are further provided.

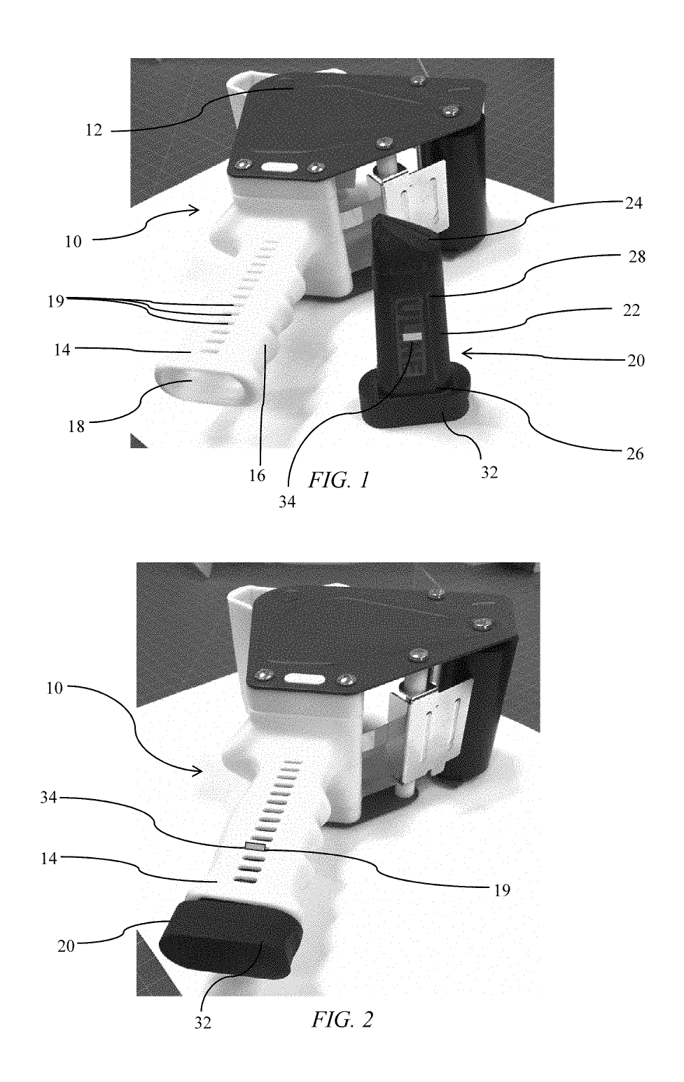

Now referring to the figures, wherein like numerals refer to like parts, FIG. 1 illustrates a packing tape dispenser 10 and a packing tape dispenser insert apparatus 20 in an embodiment of the present invention. The packing tape dispenser 10 comprises various parts typical of hand-held packing tape dispensers such as a dispensing head 12 having a roll of tape therein and a serrated blade (not shown) for dispensing and cutting a strip of tape for sealing boxes, cartons, parcels or other like containers, or for otherwise adhering to surfaces as desired. The packing tape dispenser 10 further comprises a handle 14 having a grip 16, and further comprising an interior cavity 18. A series of slots 19 may be disposed on a side thereof, and are typically found in the side of the handle of a Uline® packing tape dispenser. The slots 19 are horizontally-disposed on the side of the handle 14 and are uniform in size and shape. The slots 19 are disposed from the free end of the handle 14 to the head-end of the handle 14, although they may be positioned in any location apparent to one of ordinary skill in the art.

The tape dispenser insert apparatus 20 comprises a housing 22 comprising a first end 24, a second end 26, a first side 28 and a second side 30 (not shown in FIG. 1). Within the housing 22 may be a compartment or space for holding and/or storing items that may be useful for a user thereof. On the second end 26 may be a base 32 that is configured to be exposed and accessible when the tape dispenser insert apparatus 20 is stored within the hollow handle 14 of the tape dispenser 10, as disclosed below and illustrated in FIG. 2. The first side 28 may further comprise a tab, flange or other element 34 extending therefrom. The tab, flange or other element 34 may be spring loaded so that the same may be depressed and released, thereby moving back into its original position after depression by a user thereof.

The tape dispenser insert apparatus 20 may hold items that may be useful for a user thereof. In an exemplary embodiment illustrated below, the tape dispenser insert apparatus 20 may hold a plurality of blades, such as double-ended blades so that the same may be utilized as a box cutter. Of course, it should be noted that the tape dispenser insert apparatus 20 may hold any item useful for a user thereof in the compartment therein. As such, the tape dispenser insert apparatus 20 may comprise a door, hatch, or other means for accessing the internal compartment thereof for adding or removing items therein.

As illustrated in FIG. 2, the tape dispenser insert apparatus 20 may be inserted into the interior cavity 18 of the handle 14 through an opening at the bottom of the handle 14. The tab, flange or other element 34 may catch and extend through one of the plurality of slots 19 in the handle 14 and hold the same therein. Specifically, as the tape dispenser insert apparatus 20 is slid into the internal cavity 18 of the handle 14, the tab, flange or other element 34 may be angled so that the tab, flange or other element 34 does not catch within any of the slots 19 until the tape dispenser insert apparatus 20 cannot be inserted further. At such a point, the tab, flange or other element 34 may hold the tape dispenser insert apparatus 20 therein until released by a user. The user may, for example, depress the tab, flange or other element 34 so that the same is released from the one of the plurality of slots 19, allowing the user to remove the tape dispenser insert apparatus 20 from the handle 14. Alternatively, a release button or other release element may be accessible to a user disposed in an accessible location, such as in the base 32 thereof, such that when selected and pushed by the user, the tab, flange or other element 34 retracts thereby clearing the slots 19, enabling easy removal of the tape dispenser insert apparatus 20 from the handle 14.

Other means for holding the tape dispenser insert apparatus 20 may be utilized in place of the tab, flange or other element 34, and the present invention should be limited as described herein. For example, a magnet catch may be utilized to hold the tape dispenser insert apparatus 20 within the tape handle 14 of the tape dispenser 10. In another embodiment, a strap having a snap or button may be utilized to hold the tape dispenser apparatus 20 within the handle 14 of the tape dispenser 10.

Moreover, the tab, flange or other element 34 may catch any other location, such as other recessed portions, tabs, or other like elements that allow the tape dispenser insert apparatus 20 to remain inserted in the handle 14 of the tape dispenser 10 until removal is desired by the user thereof.

The base 32 on the second end 26 of the housing 22 may act as an impediment for the full insertion of the tape dispenser insert apparatus 20. The base 32 may further allow a user to grip the same and pull the same out of the handle 14 when desired.

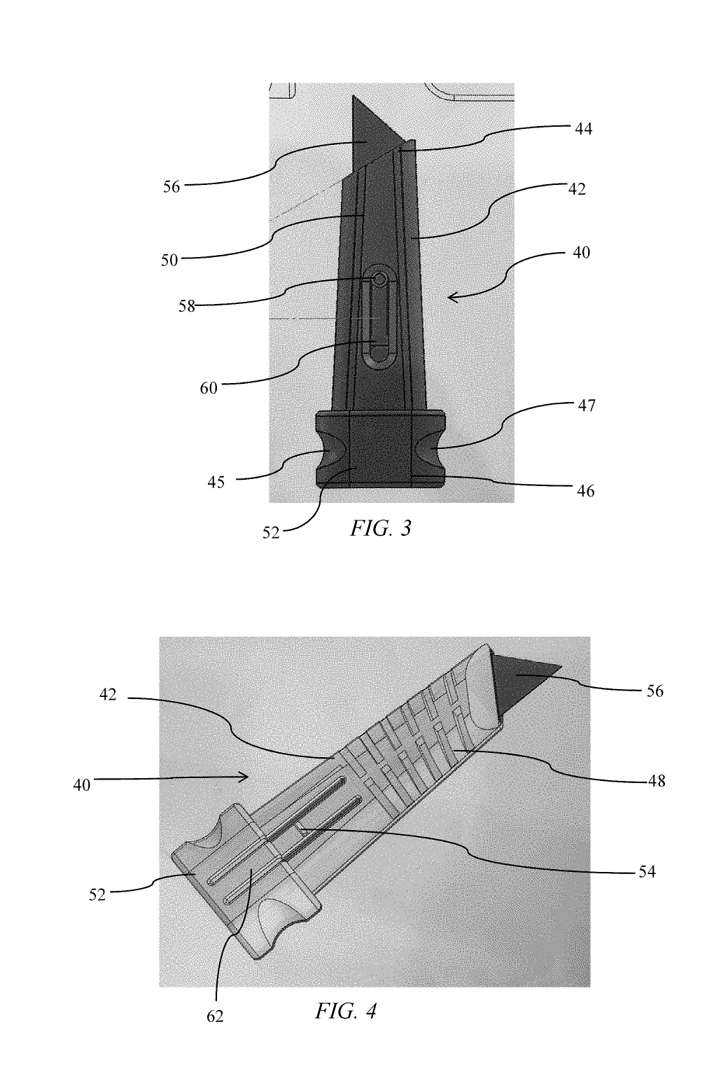

Referring now to FIGS. 3 and 4, an exemplary embodiment of the present invention is illustrated. Specifically, FIGS. 3 and 4 illustrate a box cutter tape dispenser insert apparatus 40 comprising a housing 42, a first end 44, a second end 46, a first side 48 and a second side 50. A base 52 may be disposed on the second end 46 of the box cutter tape dispenser insert apparatus 40 having convenient grips 45, 47 allowing a user to easily grasp the same, especially when removing from the handle of a tape dispenser.

The first end 44 may be angled relative to the sides of the housing, and a blade 56 may be disposed therein. A slot in the first end 44 may allow the blade 56 to extend therethrough, thereby exposing the same for use. The blade 56 may preferably be a double-ended blade that may be slidably engaged within the interior compartment of the housing 42. A slide 58 may be disposed on the second side 50 of the housing 42 to engage and slide the blade out of and back into the housing 42 through the slot in the first end 44. The slide may be disposed within a longitudinal slot 60. Thus, the box cutter tape dispenser insert apparatus 40 may be utilized as a box cutter when the blade 56 is extended.

When the blade 56 is retracted into the housing 42, the box cutter tape dispenser insert apparatus 40 may be stored and held in place within the handle of a tape dispenser, as disclosed above with respect to FIGS. 1 and 2. Further, the base 52 may act as a stop to prevent the box cutter tape dispenser insert apparatus 40 to be inserted too far into the handle due to the width of the base 52 relative to the opening at the bottom of the handle of the tape dispenser.

FIG. 4 illustrates the first side 48 of the box cutter tape dispenser insert apparatus 40 illustrated tab, flange or other element 54 that may be utilized to hold the same within the handle of the tape dispenser, as disclosed above. The tab, flange or other element 54 may be connected to a depressible strip 62 allowing the tab, flange or other element 54 to be depressed and released, as disclosed above, for allowing the box cutter tape dispenser insert apparatus 40 to be removed from the handle of the tape dispenser. The depressible strip 62 may be accessed by a user from the base 52 when the box cutter dispenser insert apparatus 40 is disposed and held within the handle of a tape dispenser. Upon pressing the same, the tab, flange or other element may be retracted, thereby pulling the tab, flange or other element 54 from the slot 19.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A packing tape dispenser insert apparatus comprising:
a housing having a first end, a second end, a first side and a second side, wherein the housing is shaped and sized to be placed within a hollow handle of a packing tape dispenser;
a holding element on the housing for engaging the hollow handle of the packing tape dispenser, the holding element configured to hold the housing within the hollow handle of the packing tape dispenser; and
a release element wherein the release element is configured to release the housing from the hollow handle of the packing tape dispenser.

2. The packing tape dispenser insert apparatus of claim 1 wherein the housing comprises at least one item.

3. The packing tape dispenser insert apparatus of claim 2 wherein the item is a razor blade.

4. The packing tape dispenser insert apparatus of claim 1 wherein the housing comprises a plurality of razor blades.

5. The packing tape dispenser insert apparatus of claim 1 wherein the holding element is a tab on the housing, wherein the tab is configured to engage a mating element on an inside surface of the hollow handle of the packing tape dispenser.

6. The packing tape dispenser insert apparatus of claim 1 wherein the holding element is magnetic.

7. The packing tape dispenser insert apparatus of claim 1 wherein the release element comprises a spring, wherein depressing the release element causes the holding element to release the housing from the hollow handle of the packing tape dispenser.

8. A packing tape dispenser insert system comprising:
a packing tape dispenser comprising a dispensing head having a roll of tape therein, a blade for dispensing and cutting a strip of tape therefrom, and a hollow handle having a grip and comprising an interior cavity therein; and
a packing tape dispenser insert apparatus comprising a housing having a first end, a second end, a first side and a second side, wherein the housing is shaped and sized to be placed within the hollow handle of the packing tape dispenser, a holding element on the housing for engaging the hollow handle of the packing tape dispenser, the holding element configured to hold the housing within the hollow handle of the packing tape dispenser, and a release element wherein the release element is configured to release the housing from the hollow handle of the packing tape dispenser.

9. The packing tape dispenser insert system of claim 8 wherein the housing comprises at least one item.

10. The packing tape dispenser insert system of claim 9 wherein the item is a razor blade.

11. The packing tape dispenser insert system of claim 8 wherein the housing comprises a plurality of razor blades.

12. The packing tape dispenser insert system of claim 8 wherein the holding element is a tab on the housing, wherein the tab is configured to engage a mating element on an inside surface of the hollow handle of the packing tape dispenser.

13. The packing tape dispenser insert system of claim 8 wherein the holding element is magnetic.

14. The packing tape dispenser insert system of claim 8 wherein the release element comprises a spring, wherein depressing the release element causes the holding element to release the housing from the hollow handle of the packing tape dispenser.

15. A method of using a packing tape insert system comprising the steps of:
providing a packing tape dispenser comprising a dispensing head having a roll of tape therein, a blade for dispensing and cutting a strip of tape therefrom, and a hollow handle having a grip and comprising an interior cavity therein; and
providing a packing tape dispenser insert apparatus comprising a housing having a first end, a second end, a first side and a second side, wherein the housing is shaped and sized to be placed within the hollow handle of the packing tape dispenser, a holding element on the housing for engaging the hollow handle of the packing tape dispenser, the holding element configured to hold the housing within the hollow handle of the packing tape dispenser, and a release element wherein the release element is configured to release the housing from the hollow handle of the packing tape dispenser;
inserting the housing into the hollow handle of the packing tape dispenser; and
engaging the holding element to the hollow handle of the packing tape dispenser.

16. The method of claim 15 further comprising the step of:
engaging the release element, wherein engaging the release element disengages the holding element from the hollow handle of the packing tape dispenser.

17. The method of claim 15 wherein the housing comprises at least one item.

18. The method of claim 17 wherein the item is a razor blade.

19. The method of claim 15 wherein the holding element is magnetic.

20. The method of claim 15 wherein the release element comprises a spring, wherein the step of engaging the release element comprises the step of:
depressing the release element, which causes the holding element to release the housing from the hollow handle of the packing tape dispenser.
